(19) United States
(12) Patent Application Publication
(10) Pub. No.: US 2006/0002066 A1
(43) Pub. Date: Jan. 5, 2006

(54) Method for protecting the display of an electronic device from scratching

(76) Inventors: Paul J. Doczy, Cypress, TX (US); Earl W. Moore, Cypress, TX (US); Ronald E. DeLuga, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/884,036

(22) Filed: Jul. 1, 2004

(51) Int. Cl. G06F 1/16

(52) U.S. Cl. 361/683

(57) ABSTRACT

Pads placed in an interior region of the inner surface of a first enclosure of an electronic device protect a display on the inner surface of a second, hingeably attached enclosure against scratching or scuffing, when the first and second enclosures are closed upon each other and the closed device is subjected to a compressive force. The technique may be applied to a wide variety of electronic devices that have a “clam shell” design.

### FIELD OF THE INVENTION

The present invention relates generally to electronic devices and more specifically to techniques for preventing the scratching or scuffing of the display of such a device.

### BACKGROUND OF THE INVENTION

A variety of electronic devices such as notebook computers, cellular phones, personal digital assistants (PDAs), and portable DVD players have a “clam shell” design, in which two “shells” (housings or enclosures) are pivotably attached along an edge, allowing the two enclosures to close upon each another. Often, the inner surface of one enclosure (typically the bottom enclosure) includes a keyboard or set of control buttons, and the inner surface of the other enclosure (typically the top enclosure) includes a display. When the device is closed, the display may be a very short distance from the keyboard or control buttons. If a compressive force is applied to the outside of the closed device, the keyboard or control buttons may come into contact with the display, scratching or scuffing it.

It is thus apparent that there is a need in the art for an improved apparatus and method for protecting the display of an electronic device from scratching.

### SUMMARY OF THE INVENTION

A method for protecting the display of an electronic device from scratching is provided. At least one pad may be placed in an interior region of an inner surface of a first enclosure of the electronic device, the first enclosure being pivotably attached to a second enclosure along an edge, the inner surface of the first enclosure including a keyboard, an inner surface of the second enclosure including the display, the inner surfaces of the first and second enclosures being closeable upon each other, the at least one pad being a first point of contact between the display and the inner surface of the first enclosure to prevent damage to the display, when the first and second enclosures are closed upon each other and the closed electronic device is subjected to a compressive force. An electronic device incorporating the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is an illustration of an electronic device in accordance with an illustrative embodiment of the invention.

FIG. 1B is a side view of the electronic device shown in FIG. 1A in accordance with an illustrative embodiment of the invention.

FIG. 2 is a flowchart of a method for protecting the display of an electronic device from scratching in accordance with an illustrative embodiment of the invention.

### DETAILED DESCRIPTION OF THE INVENTION

Scratching of the display may occur if the keyboard or control buttons are the first point of contact with the display when the closed device is subjected to a compressive force (e.g., the device is squeezed, or a heavy object is placed on top of it). This can be prevented by placing, in an interior region of the inner surface of the enclosure that includes the keyboard or control buttons, one or more pads made of a soft material so that the first point of contact with the display is the soft pads instead of the keyboard or control buttons. Such pads may, for example, be composed of a soft elastomer, and their protective purpose may be accomplished by making them slightly taller than the keyboard or control buttons. Appropriately placed, the pads do not interfere with normal use of the electronic device.

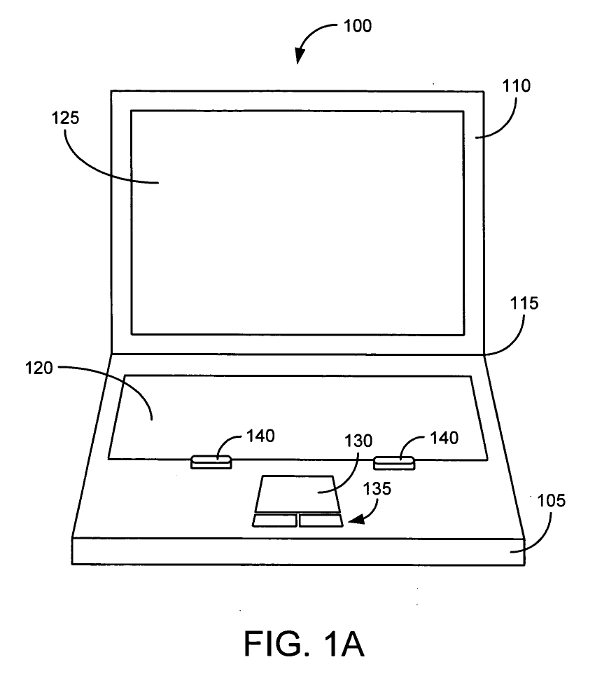

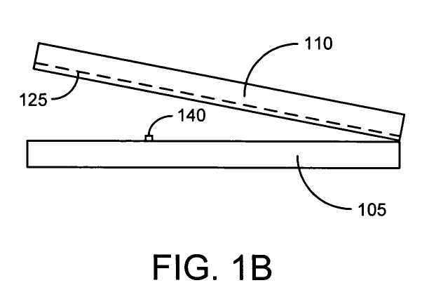

FIG. 1A is an illustration of an electronic device 100 in accordance with an illustrative embodiment of the invention. Although FIG. 1A depicts a notebook computer, electronic device 100 may be any electronic device that has a similar “clam shell” design, including, but not limited to, laptop computers, notebook computers, PDAs, radiotelephones (e.g., a cellular, cordless, or PCS phone), and portable DVD players. In FIG. 1A, electronic device 100 has a first enclosure 105 and a second enclosure 110 that are hingeably attached along edge 115. First and second enclosures 105 and 110, respectively, may be closed upon each other, their respective inner surfaces coming into close proximity when electronic device 100 is closed. The top (inner) surface of first enclosure 105 includes keyboard deck 120. Keyboard deck 120 may, in some embodiments, house a full (alphanumeric) keyboard, or it may instead house one or more control buttons that control the functions of electronic device 100. Throughout this detailed description, either type of collection of buttons or keys within keyboard deck 120 will be referred to as a “keyboard.” The inner surface of second enclosure 110 includes display 125. Display 125 is typically of the liquid-crystal-display (LCD) type. The inner surface of first enclosure 105 may optionally include touchpad 130 and left and right control buttons 135. Touchpad 130 is a touch-sensitive area that responds to the touch and movement of a user's finger much like a mouse or other pointing device. Left and right control buttons 135 may behave much like the left and right buttons on a two-button mouse.

In an interior region (i.e., not along the perimeter) of the inner surface of first enclosure 105, electronic device 100 may also include one or more pads 140 made of a soft material, such as a soft elastomer. In the example of FIG. 1A, pads 140 are situated on either side of touchpad 130 between touchpad 130 and keyboard deck 120 on the inner surface of first enclosure 105. In other embodiments, pads 140 may be larger in size than those depicted in FIG. 1A or greater than two in number. It is advantageous for pads 140 to be substantially near the center of the inner surface of first enclosure 105, but that is not a requirement. The placement shown in FIG. 1A strikes a compromise between a central location that maximizes protection of display 125 and one that does not interfere with the layout and use of keyboard deck 120.

FIG. 1B is a side view of electronic device 100 shown in FIG. 1A in accordance with an illustrative embodiment of the invention. In FIG. 1B, second enclosure 110 is shown nearly closed upon first enclosure 105. Since pads 140 extend higher from the inner surface of first enclosure 105 than keyboard deck 120, pads 140 are the first point of contact between display 125 and the inner surface of first enclosure 105 when the closed electronic device 100 is subjected to a compressive force. This protects display 125 against the scratching or scuffing that would otherwise result if display 125 were to come into contact with keyboard deck 120.

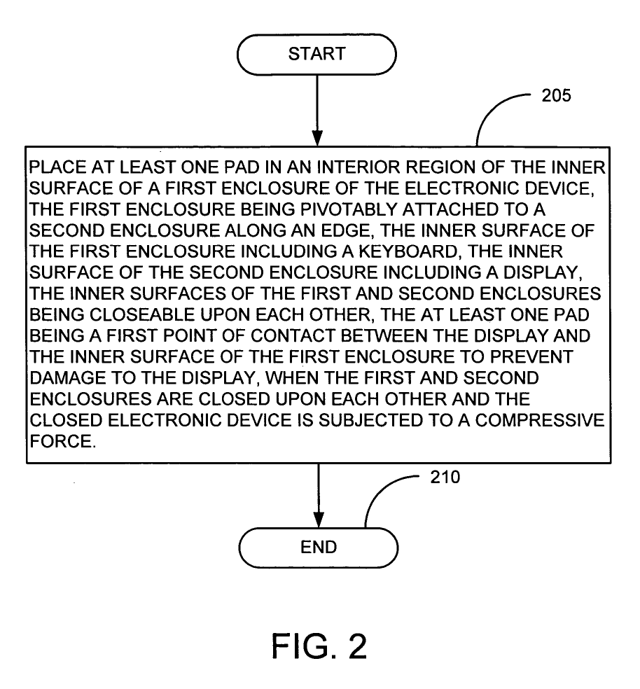

FIG. 2 is a flowchart of a method for protecting the display of an electronic device 100 from scratching in accordance with an illustrative embodiment of the invention. At 205, at least one pad 140 is placed in an interior region of the inner surface of first enclosure 105, as explained in connection with FIGS. 1A and 1B. As shown in FIG. 1B, pads 140 are the first point of contact between display 125 and the inner surface of first enclosure 105, when first and second enclosures 105 and 110, respectively, are closed upon each other and electronic device 100 is subjected to a compressive force. At 210, the process terminates.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An electronic device, comprising:
first and second enclosures that are hingeably attached along an edge, the first enclosure having an inner surface that includes a keyboard, the second enclosure having an inner surface that includes a display, the inner surfaces of the first and second enclosures being closeable upon each other; and
at least one pad in an interior region of the inner surface of the first enclosure, the at least one pad being a first point of contact between the display and the inner surface of the first enclosure to prevent damage to the display, when the first and second enclosures are closed upon each other and the closed electronic device is subjected to a compressive force.

2. The electronic device of claim 1, wherein the at least one pad is composed of a soft elastomer.

3. The electronic device of claim 1, wherein the inner surface of the first enclosure further includes a touchpad near a front edge opposite the edge along which the first and second enclosures are hingeably attached and the at least one pad comprises two pads located on either side of the touchpad between the touchpad and the keyboard.

4. The electronic device of claim 1, wherein the electronic device is one of a laptop computer, a notebook computer, a radiotelephone, a PDA, and a portable DVD player.

5. A method for protecting a display of an electronic device from scratching, comprising:
placing at least one pad in an interior region of an inner surface of a first enclosure of the electronic device, the first enclosure being pivotably attached to a second enclosure along an edge, the inner surface of the first enclosure including a keyboard, an inner surface of the second enclosure including the display, the inner surfaces of the first and second enclosures being closeable upon each other, the at least one pad being a first point of contact between the display and the inner surface of the first enclosure to prevent damage to the display, when the first and second enclosures are closed upon each other and the closed electronic device is subjected to a compressive force.

6. The method of claim 5, wherein the at least one pad is composed of a soft elastomer.

7. The method of claim 5, wherein the inner surface of the first enclosure further includes a touchpad near a front edge opposite the edge along which the first and second enclosures are pivotably attached and placing at least one pad in an interior region of an inner surface of a first enclosure of the electronic device comprises placing a pad on either side of the touchpad between the touchpad and the keyboard.

8. The method of claim 5, wherein the electronic device is one of a laptop computer, a notebook computer, a radiotelephone, a PDA, and a portable DVD player.

9. An electronic device, comprising:
first and second enclosures that are hingeably attached along an edge, the first enclosure having an inner surface that includes a keyboard, the second enclosure having an inner surface that includes a display, the inner surfaces of the first and second enclosures being closeable upon each other; and
means for initially contacting the display with a portion of the inner surface of the first enclosure that prevents the keyboard from scratching the display, when the first and second enclosures are closed upon each other and the closed electronic device is subjected to a compressive force.

10. The electronic device of claim 9, wherein the means for initially contacting the display with a portion of the inner surface of the first enclosure that prevents the keyboard from scratching the display comprises at least one pad in an interior region of the inner surface of the first enclosure, the at least one pad extending higher from the inner surface of the first enclosure than the keyboard.

11. The electronic device of claim 10, wherein the at least one pad is composed of a soft elastomer.

12. The electronic device of claim 10, wherein the inner surface of the first enclosure further includes a touchpad near a front edge opposite the edge along which the first and second enclosures are hingeably attached and the at least one pad comprises two pads located on either side of the touchpad between the touchpad and the keyboard.

13. The electronic device of claim 9, wherein the electronic device is one of a laptop computer, a notebook computer, a radiotelephone, a PDA, and a portable DVD player.
